(19) United States
(12) Patent Application Publication
(10) Pub. No.: US 2025/0256589 A1
(43) Pub. Date: Aug. 14, 2025

(54) VERTICAL RANGE ESTIMATION FOR TIRED MACHINE

(71) Applicant: Caterpillar Inc., Peoria, IL (US)

(72) Inventors: Alexander Eli DOWLING, Mt. Hicks (AU); Brodie Lee THOMPSON, West Ulverstone (AU); Robert A. HEROLD, Brimfield, IL (US)

(73) Assignee: Caterpillar Inc., Peoria, IL (US)

(21) Appl. No.: 18/440,509

(22) Filed: Feb. 13, 2024

(51) Int. Cl. B60L 50/60; B60L 58/13; B60L 58/16

(52) U.S. Cl. CPC B60L 50/66; B60L 58/13; B60L 58/16

(57) ABSTRACT

A battery electric machine configured to carry a payload includes a propulsion system, including an electric motor, configured to propel the battery electric machine; a battery module including battery terminals configured to connect to a primary battery and provide power to the propulsion system; and a processing circuit configured to calculate a total mass based on a sum of a payload mass of the payload and a machine mass of the battery electric machine. The processing circuit is further configured to monitor an existing potential energy of the primary battery, estimate a remaining upward vertical distance that the battery electric machine can travel based on a first vertical estimation algorithm, the total mass, and the existing potential energy, and estimate a remaining downward vertical distance that the battery electric machine can travel based on a second vertical estimation algorithm, the total mass, and the existing potential energy.

### TECHNICAL FIELD

The present disclosure relates generally to a tired machine with a vertical range estimator.

### BACKGROUND

A battery electric machine is a machine that uses an electric engine to operate. A battery may supply power to the electric engine for operation. An underground battery electric machine, such as a hauler or a haul truck, may be used in an underground mine for hauling a payload. A hauler is one type of rubber-tired vehicle. Underground mining frequently necessitates material transfer from one vertical elevation to another via underground machinery that moves from one vertical level to another vertical level within an underground mine. For example, when operated in the underground mine, the underground battery electric machine may move from one vertical elevation to another vertical elevation within the underground by moving on an incline (e.g. uphill) or a decline (e.g., downhill) from one vertical level to another vertical level of the underground mine. Typically, the vertical levels are configured in predetermined offsets that are spaced roughly at equal intervals across a vertical delta.

The underground battery electric machine may include a means for estimating and displaying to an operator an available battery charge (e.g., a state of charge (SoC)) and, based on various parameters, a remaining rolling distance that the battery electric machine can travel based on the available battery charge. However, in underground mining applications, operators tend to measure movement in terms of a vertical distance traveled within the underground mine, rather than a horizontal distance traveled or rolling distance traveled. For example, the operator may have a better sense of how much vertical distance needs to be covered for performing a desired task, rather than how much horizontal distance needs to be covered for performing the desired task. For example, the operator may need to know how many vertical levels up or down the underground battery electric machine can travel within the underground mine on a remaining charge. Rolling distance may not be a good indicator that allows the operator to the estimate the number of vertical levels up or down the underground battery electric machine can travel on the remaining charge. Thus, a remaining vertical distance that can be traveled on the available battery charge may be more meaningful to the operator of the underground battery electric machine than a remaining rolling distance. Moreover, having uncertainty with respect to the remaining vertical distance that can be traveled on the available battery charge can cause the operator to develop range anxiety.

In the upward case, uncertainty with respect to the remaining vertical distance that can be traveled on the available battery charge may cause the underground battery electric machine to become stranded (e.g., on a ramp, or on a wrong level), thus disrupting operations and/or requiring a charging machine to rescue the underground battery electric machine. In a downward case, uncertainty with respect to the remaining vertical distance that can be traveled on the available battery charge may cause the underground battery electric machine to become stranded (e.g., on a ramp, or on a wrong level), or enter a derated state which may slow down machine traffic behind the underground battery electric machine, thus disrupting operations by causing congestion.

The method of providing vertical distance information for a battery electric machine of the present disclosure solves one or more of the problems set forth above and/or other problems in the art. The method of providing vertical distance information of the present disclosure may also be used in tired machines that use other types of power sources, such as gasoline or diesel fuel.

### SUMMARY

In some implementations, a battery electric machine configured to carry a payload includes a propulsion system, including an electric motor, configured to propel the battery electric machine; a battery module comprising battery terminals configured to connect to a primary battery and provide power to the propulsion system; a processing circuit configured to monitor an existing potential energy of the primary battery, estimate a remaining upward vertical distance that the battery electric machine can travel based on a first vertical estimation algorithm and the existing potential energy, and estimate a remaining downward vertical distance that the battery electric machine can travel based on a second vertical estimation algorithm and the existing potential energy; and a display configured to indicate the remaining upward vertical distance and the remaining downward vertical distance.

In some implementations, a tired machine configured to carry a payload includes a propulsion system, including an electric motor, configured to propel the tired machine; a battery module comprising battery terminals configured to connect to a battery and provide power to the propulsion system; a vertical distance estimator comprising at least one processor, where the vertical distance estimator is configured to determine the payload mass of the payload, wherein the vertical distance estimator is further configured to monitor a state of charge (SoC) of the battery and calculate a first potential energy value of the battery and a second potential energy value of the battery based on the SoC, wherein the vertical distance estimator is further configured to estimate a remaining upward vertical distance that the tired machine can travel based on a first vertical estimation algorithm, the payload mass, and the first potential energy value, and wherein the vertical distance estimator is further configured to estimate a remaining downward vertical distance that the tired machine can travel based on a second vertical estimation algorithm, the payload mass, and the second potential energy value; and a display configured to indicate the remaining upward vertical distance and the remaining downward vertical distance.

In some implementations, a method of providing vertical distance information for a tired machine configured to carry a payload includes supplying, by a battery module, power from a battery to an electric motor; calculating, by a processing circuit, a total mass based on a sum of a payload mass of the payload and a machine mass of the tired machine; monitoring, by the processing circuit, an SoC of the battery; calculating, by the processing circuit, a first potential energy value of the battery and a second potential energy value of the battery based on the SoC; estimating, by the processing circuit, a remaining upward vertical distance that the tired machine can travel based on a first vertical estimation algorithm, the total mass, and the first potential energy value; estimating, by the processing circuit, a remaining downward vertical distance that the tired machine can travel based on a second vertical estimation algorithm, the total mass, and the second potential energy value; and displaying, by a display, the vertical distance information, including the remaining upward vertical distance and the remaining downward vertical distance.

### BRIEF DESCRIPTION OF THE DRAWINGS

FIG. 1 shows a battery electric machine that includes a vertical distance estimator according to one or more implementations.

FIG. 2 shows a schematic block diagram of a system of a battery electric machine according to one or more implementations.

FIG. 3 shows an example of an efficiency table according to one or more implementations.

FIG. 4 is a flowchart of an example process associated with vertical range estimation for a battery electric machine.

### DETAILED DESCRIPTION

This disclosure relates to a battery electric machine, which is applicable to any machine that includes a propulsion system, including an electric motor, configured to propel the battery electric machine. The battery electric machine may include a battery module comprising battery terminals configured to connect to a battery and provide power to the propulsion system. For example, the battery electric machine may be an underground battery electric machine, a rubber-tired machine, a hauler, a haul truck, an underground articulated truck, a tractor, an excavator, a dozer, or the like.

The battery electric machine may include a vertical distance estimator that calculates a remaining height or a remaining vertical distance that the battery electric machine can travel on an available battery charge. The vertical distance estimator may provide two directional estimations for remaining vertical distance, including one remaining vertical distance (e.g., a remaining upward vertical distance or a remaining uphill vertical distance) that the battery electric machine can travel before battery depletion, and another remaining vertical distance (e.g., a remaining downward vertical distance or a remaining downhill vertical distance) that the battery electric machine can travel before battery saturation. In other words, the vertical distance estimator may calculate two directional estimations for remaining vertical distance, including a first remaining vertical distance if the battery electric machine were to travel uphill from a current position, and a second remaining vertical distance if the battery electric machine were to travel downhill from the current position. The battery electric machine may include a display that receives remaining vertical distance information received from the vertical distance estimator and displays the remaining vertical distance information (e.g., uphill vertical range and downhill vertical range) to the operator. Providing the remaining vertical distance information to the operator may help to prevent the operator from developing range anxiety and may facilitate more efficient operation of the battery electric machine and/or may enable more efficient navigation in an underground mine, including improved coordination between vehicles traversing the underground mine. The display may also be configured to indicate the available battery charge (e.g., SoC) to the operator. A horizontal distance estimator may also be configured to calculate remaining rolling distance information for uphill and downhill travel, and provide the remaining rolling distance information to the display.

The vertical distance estimator may calculate the remaining vertical distance information as a function of efficiency data that may be initially estimated based on an environment and/or an estimated performance of the battery electric machine. The efficiency data may be updated based on historical trips by the battery electric machine. Efficiency data may be recorded by the vertical distance estimator based on the performance of the battery electric machine. Additionally, or alternatively, efficiency data may be received from one or more other battery electric machines (e.g., via machine-to-machine communications) and/or from a site control system that has historical data. Efficiency tables may be used to store the efficient data. The efficiency tables may include efficiency tables associated with a primary battery and a secondary battery. In addition, the efficiency tables may include efficiency data for uphill travel and downhill travel for each battery. Thus, the efficiency tables may include an uphill primary battery efficiency table, a downhill primary battery efficiency table, an uphill secondary battery efficiency table, and/or a downhill secondary battery efficiency table. The efficiency tables may be lookup tables that may be used to assess a machine efficiency that is used in conjunction with factors such as vehicle mass, payload, rolling resistance, or the like, to output a height (e.g., available vertical distance) that can be travelled by the battery electric machine given a current SoC.

The primary battery may be swapped with a replacement primary battery to be recharged at a charging station. Thus, the primary battery may serve as a primary power source to provide electricity to the propulsion system during ordinary operations, and the secondary battery may be used for operating the battery electric machine during a battery swap of the primary battery. After the battery swap, the secondary battery may remain on the battery electric machine to be recharged by the replacement primary battery. Thus, the vertical distance estimator may factor in an amount of recharge energy needed from the replacement primary battery to recharge the secondary battery for calculating the two directional estimations for remaining vertical distance.

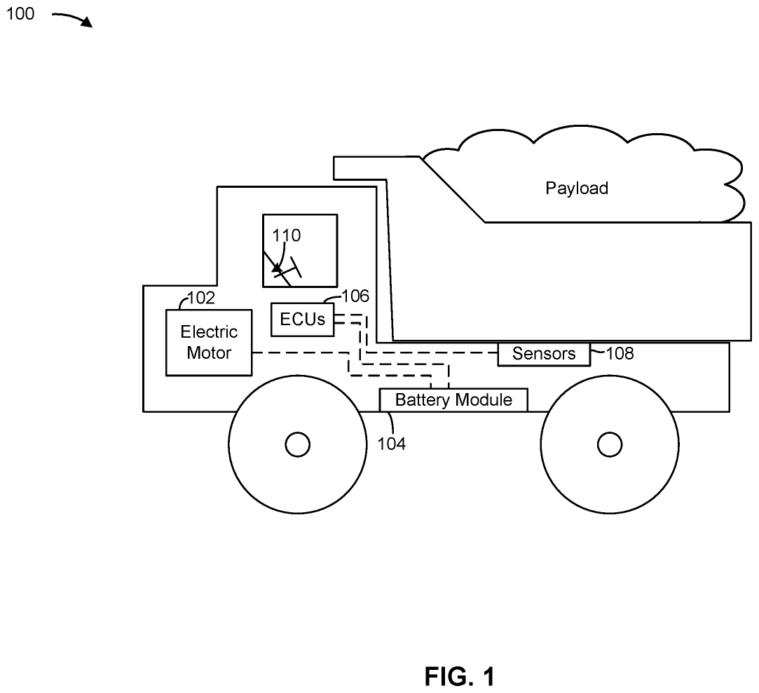

FIG. 1 shows a battery electric machine 100 that includes a vertical distance estimator according to one or more implementations. The battery electric machine 100 may be a rubber-tired machine, such as a haul truck used for underground mine applications, that is configured to carry a payload, such as dirt, minerals, or other material. A tired machine may be a machine that rolls on tires for movement. The battery electric machine 100 may include an electric motor 102, a battery module 104, one or more electronic control units (ECUs) 106, one or more sensors 108, and a display 110. The electric motor 102 may be part of a propulsion system that is configured to propel the battery electric machine 100. For example, the electric motor 102 may cause the wheels of the battery electric machine 100 to rotate.

The battery module 104 may include battery terminals configured to connect to a primary battery and provide power to the propulsion system (e.g., to the electric motor 102) and other electric components of the battery electric machine 100, such as the ECUs 106. The primary battery may be removably inserted into a battery slot or receptacle of the battery module 104. For example, the primary battery may be swapped with a replacement primary battery. The battery module 104 may include battery terminals configured to connect to a secondary battery and provide secondary power to the propulsion system (e.g., to the electric motor 102) and other electric components of the battery electric machine 100, such as the ECUs 106. For example, the battery module 104 may connect and route power to the electric motor 102 and other electric components of the battery electric machine 100 when the primary battery is depleted or when the primary battery is removed from the battery module 104 during a battery swap. Thus, the battery module 104 may control which battery is connected for supplying power. In addition, the battery module 104 may route power from the replacement primary battery to the secondary battery to recharge the secondary battery.

An ECU is any embedded system in vehicle electronics that controls one or more of the electrical systems or subsystems in a vehicle. Each ECU may include a microcontroller (i.e., a microcontroller unit (MCU)), a memory, various inputs (e.g., supply voltage, digital inputs, and/or analog inputs) and outputs (e.g., control outputs, driver outputs, and/or logic outputs), and communication links. Thus, each ECU may include one or more processors or processing circuits that receive and process information to generate one or more outputs. Thus, the ECUs may be nodes of in-vehicle networks, while edges of those in-vehicle networks may be communication networks.

A non-exhaustive list of ECU types includes an engine control module (ECM), an engine control unit, a transmission control unit (TCU), a transmission control module (TCM), a brake control module (BCM), a central control module (CCM), a central timing module (CTM), a general electronic module (GEM), a body control module (BCM), a suspension control module (SCM), a door control unit (DCU), an electric power steering control unit (PSCU), a human-machine interface (HMI), a seat control unit, a speed control unit (SCU), a telematic control unit (TCU), and a battery management system (BMS). Sometimes the functions of the engine control unit and the TCU are combined into a single ECU called a powertrain control module (PCM). In addition, the BCM may be configured to control an anti-lock braking system (ABS), electronic stability control (ESC), and/or dynamic stability control (DSC). The vertical distance estimator may be part of a BMS, and may include a processing circuit configured to estimate a remaining upward vertical distance that the battery electric machine can travel based on an available battery charge (e.g., SoC) and estimate a remaining downward vertical distance that the battery electric machine can travel based on the available battery charge.

The one or more sensors 108 may sense a payload mass of the payload and generate at least one sensor signal representative of the payload mass. For example, the one or more sensors 108 may include one or more pressure sensors (e.g., strain gauges, piezoelectric sensors) and/or one or more torque sensors for sensing the payload mass. The vertical distance estimator may be configured to evaluate a pressure or strain sensed and extrapolate the pressure or the strain to the payload mass of the payload. The vertical distance estimator may be configured to evaluate a torque sensed during transit (e.g., torque at one or more of the axles or wheels) and extrapolate the torque to a mass value, such as the payload mass or a total mass. The total mass may be a sum of the payload mass and a machine mass of the battery electric machine. Alternatively, the vertical distance estimator may receive payload mass information by another means, such as via machine-to-machine communication, a transmission from a site control system, and/or manual input from an operator. The vertical distance estimator may calculate the total mass based on preset values for the battery electric machine (e.g., a preset value for the machine mass) and a payload value added based on feedback from an onboard system. The vertical distance estimator may calculate the remaining upward vertical distance and the remaining downward vertical distance as a function of the payload mass and/or the total mass.

The display 110 may indicate the remaining upward vertical distance and the remaining downward vertical distance to the operator. Thus, the display 110 or an HMI may be electrically coupled to the vertical distance estimator for receiving the remaining upward vertical distance and the remaining downward vertical distance. The remaining upward vertical distance and the remaining downward vertical distance may be indicated simultaneously on the display 110.

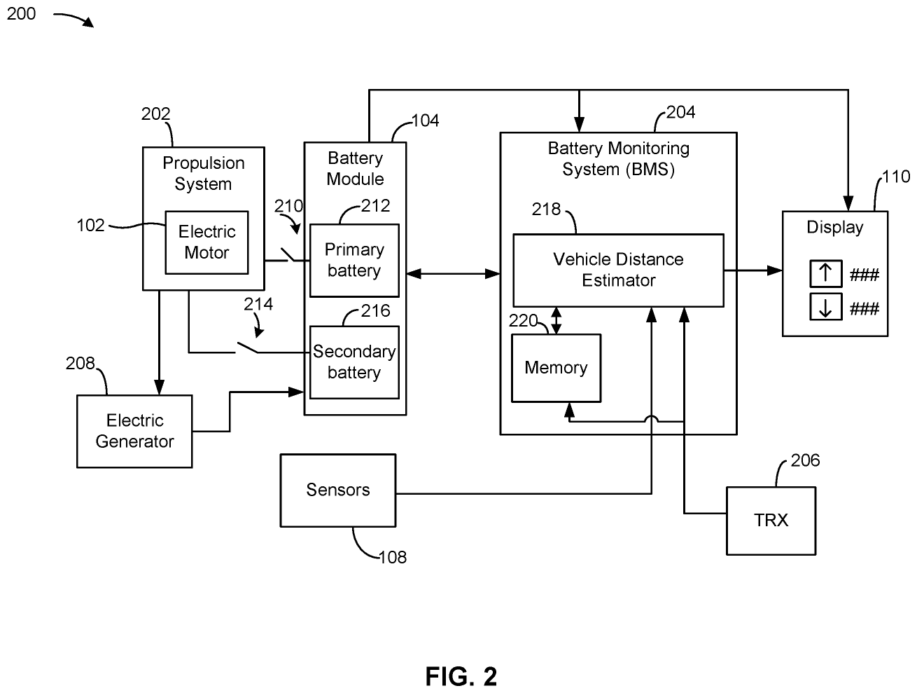

FIG. 2 shows a schematic block diagram of a system 200 of a battery electric machine according to one or more implementations. The battery electric machine may be similar to the battery electric machine 100 described in connection with FIG. 1. The system 200 may include the battery module 104, one or more sensors 108, and the display 110. Additionally, the system 200 may include a propulsion system 202, a BMS 204, a transceiver (TRX) 206, and an electric generator 208. The propulsion system 202 may include the electric motor 102. The battery module 104 may include battery terminals 210 configured to connect to a primary battery 212, and battery terminals 214 configured to connect to a secondary battery 216 (e.g., an auxiliary battery). The battery terminals 210 and the battery terminals 214 may be selectively coupled and decoupled to a power routing network (e.g., a power bus) of the battery electric machine for providing power. For example, the secondary battery 216 may be decoupled from the power routing network, including the electric motor 102, when the primary battery 212 is coupled to the power routing network, and the primary battery 212 may be decoupled from the power routing network when the secondary battery 216 is coupled to the power routing network. Additionally, the primary battery 212 may be coupled to the secondary battery 216 to recharge the secondary battery (for example, after a battery swap). Thus, the battery module 104 may, while using the primary battery 212 as a power source, recharge the secondary battery 216 with recharge energy routed from the primary battery 212.

Additionally, the battery electric machine may perform a regenerative function during downhill operation to recharge the primary battery 212. For example, the battery electric machine may use regenerative braking while the battery electric machine is traveling downhill in order to recharge the primary battery 212. The electric generator 208 may generate electricity during downhill operation and transfer the electricity to the battery module 104 for recharging the primary battery 212. Thus, the primary battery 212 may be discharged toward depletion (e.g., a depletion limit) during uphill operations and may be charged toward saturation during downhill operations. The depletion limit may correspond to a full depletion of the primary battery 212 (e.g., 100% depleted) or to some margin above full depletion (e.g., 95% depleted). When the primary battery 212 reaches a saturation limit, the battery electric machine may operate in a derated state. For example, the saturation limit may correspond to a fully charged state (e.g., 100% charged or fully saturated) or some margin below full saturation, such as 95% saturated (e.g., 5% discharged). Operating the battery electric machine in the derated state may cause the electric motor 102 to operate at a reduced capability (e.g., reduced speed). As a result, it may be useful to the operator of the battery electric machine to be aware of a remaining upward vertical distance that the battery electric machine can travel before the primary battery 212 reaches the depletion limit, and to be aware of a remaining downward vertical distance that the battery electric machine can travel before the primary battery 212 reaches the saturation limit.

The remaining upward vertical distance may correspond to an increase in elevation relative to a current position or elevation of the battery electric machine, and the remaining downward vertical distance may correspond to a decrease in elevation relative to the current position or elevation of the battery electric machine. In other words, the remaining upward vertical distance and the remaining downward vertical distance may correspond to vertical distances along a vertical plane, and the battery electric machine may be configured to travel along a driving plane or rolling plane that intersects the vertical plane.

The remaining upward vertical distance may be a first vertical range that the battery electric machine can travel in an upward vertical direction before reaching a depletion limit of an active battery, such as the primary battery 212. The remaining downward vertical distance may be a second vertical range that the battery electric machine can travel in a downward vertical direction before reaching a saturation limit of the active battery. The active battery may be a battery that is presently coupled to the power routing network for supplying power.

The BMS 204 may include a vertical distance estimator 218 and a memory device 220 that is configured to store one or more vertical estimation algorithms that may be executed by the vertical distance estimator 218 to calculate the remaining upward vertical distance and the remaining downward vertical distance. The memory device 220 may also store efficiency data, which may be stored in one or more efficiency tables, that the vertical distance estimator 218 may use in conjunction with the one or more vertical estimation algorithms for calculating the remaining upward vertical distance and the remaining downward vertical distance. The vertical distance estimator 218 may include processing circuitry, including one or more processors, configured to receive information, calculate the remaining upward vertical distance and the remaining downward vertical distance based on the information, and provide the remaining upward vertical distance and the remaining downward vertical distance to the display 110 for output to the operator of the battery electric machine. The information may be provided to the vertical distance estimator 218 by one or more sensors 108, by the transceiver 206, and/or by the memory device 220. The transceiver 206 may receive information from another battery electric machine or from a site control system.

In some implementations, the vertical distance estimator 218 may be a controller configured to test and/or monitor battery performance parameters of a battery (e.g., SoC and state of health (SoH)), calculate the remaining upward vertical distance and the remaining downward vertical distance, and provide the remaining upward vertical distance and the remaining downward vertical distance to the display 110.

The vertical distance estimator 218 may determine the payload mass of the payload. For example, the vertical distance estimator 218 may determine the payload mass based on information received from one or more sensors 108, by the transceiver 206, by the memory device 220, and/or from manual input from the operator. In some implementations, the one or more sensors 108 may sense the payload mass of the payload, generate at least one sensor signal representative of the payload mass, and provide the at least one sensor signal to the vertical distance estimator 218. The vertical distance estimator 218 may receive the at least one sensor signal and determine the payload mass from the at least one sensor signal. The vertical distance estimator 218 may calculate the remaining upward vertical distance and the remaining downward vertical distance as a function of the payload mass. For example, the vertical distance estimator 218 may use the payload mass as an input variable of the one or more vertical estimation algorithms. In some cases, the vertical distance estimator 218 may calculate a total mass Mₜₒₜₐₗ based on a sum of the payload mass, indicated by the at least one sensor signal, and the machine mass of the battery electric machine, and calculate the remaining upward vertical distance and the remaining downward vertical distance as a function of the total mass Mₜₒₜₐₗ. For example, the vertical distance estimator 218 may use the total mass Mₜₒₜₐₗ as an input variable of the one or more vertical estimation algorithms. The machine mass may be stored in the memory device 220 as a preset value and may be retrieved by the vertical distance estimator 218 for performing the calculations of the remaining upward vertical distance and the remaining downward vertical distance.

The vertical distance estimator 218 may monitor an existing potential energy of the primary battery 212, estimate the remaining upward vertical distance that the battery electric machine can travel based on a first vertical estimation algorithm, the total mass Mₜₒₜₐₗ, and the existing potential energy, and estimate the remaining downward vertical distance that the battery electric machine can travel based on a second vertical estimation algorithm, the total mass, and the existing potential energy. The existing potential energy may correspond to the SoC of a battery, and may further depend on other battery variables, such as an SoH of the battery, and a nameplate capacity N_{c} of the battery. “SoC” may refer to a remaining usable energy within the battery. SoC may exclude reserved upper and lower limits of the battery's energy and may also be inclusive of an imbalance present within battery cells of the battery. SoH may be a measure of the battery's degradation, where the battery's energy density has degraded over time due to use. The nameplate capacity N_{c} may be a total energy available if the battery were to discharge at a 1 C rate over the course of one hour. The first vertical estimation algorithm may be provided by Equation 1, and the second vertical estimation algorithm may be provided by Equation 2.

$${h}_{u p} = \frac{{N}_{c} \cdot SoC \cdot SoH \cdot Cjoules}{{M}_{total} \cdot g} {W}_{effu} \qquad Eq . 1$$

$${h}_{down} = \frac{{N}_{c} ( 1 - S o C ) SoH \cdot Cjoules}{{M}_{total} \cdot g} {W}_{effd} \qquad Eq . 2$$

The remaining upward vertical distance is denoted by hᵤₚ, and the remaining downward vertical distance is denoted by h_{down}. In addition, gravity (e.g., 9.81 m/s²) is denoted by g, and may be used in conjunction with the total mass Mₜₒₜₐₗ to calculate a total weight of the battery electric machine, including a machine weight and a payload weight. Cⱼₒᵤₗₑₛ represents a conversion from kilowatt-hour (kw-hr) to joules per second (J/s).

The existing potential energy for uphill movement may be represented by N_{c}·SoC·SoH, and the existing potential energy for uphill movement may be represented by N_{c}(1−SoC)SoH. Thus, N_{c}·SoC·SoH may correspond to a first potential energy value of the primary battery 212, and N_{c}(1−SoC)SoH may correspond to a second potential energy value of the primary battery 212. The vertical distance estimator 218 may monitor the SoC and the SoH of the primary battery 212, and calculate the first potential energy value and the second potential energy value based on the SoC and the SoH according to Equations 1 and 2, respectively. In some cases, the first potential energy value may be limited or scaled down by a limit value Rlim to account for a depletion limit of the primary battery 212. Similarly, the second potential energy value may be limited or scaled down by the limit value Rlim to account for a saturation limit of the primary battery 212.

The vertical distance estimator 218 may estimate the remaining upward vertical distance hᵤₚ that the battery electric machine can travel based at least on the first vertical estimation algorithm, the payload mass, and the first potential energy value. Furthermore, the vertical distance estimator 218 may estimate the remaining downward vertical distance h_{down} that the battery electric machine can travel based on at least the second vertical estimation algorithm, the payload mass, and the second potential energy value.

Optionally, the remaining upward vertical distance may be calculated based on a weighted upward efficiency value W_{effu}, and the remaining downward vertical distance may be calculated based on a weighted downward efficiency value W_{effd}. The weighted upward efficiency value W_{effu} may correspond to an uphill operational efficiency of the battery electric machine when using the primary battery 212 as a power source to travel uphill. Thus, the uphill operational efficiency may be an operational efficiency of the battery electric machine while using the primary battery 212 for uphill movement. Moreover, the weighted upward efficiency value W_{effu} may correspond specifically to a particular battery electric machine and a particular battery. The weighted downward efficiency value W_{effd} may correspond to a downhill operational efficiency of the battery electric machine when using the primary battery 212 as a power source to travel downhill. Thus, the downhill operational efficiency may be an operational efficiency of the battery electric machine while using the primary battery 212 for downhill movement. Moreover, the weighted downward efficiency value W_{effd} may correspond specifically to a particular battery electric machine and a particular battery.

The vertical distance estimator 218 may calculate the SoH of the primary battery 212, calculate the SoC of the primary battery 212, and calculate the existing potential energy based on the SoH and the SoC of the primary battery 212 (e.g., as a function of the SoH and the SoC). In some implementations, the vertical distance estimator 218 may calculate the existing potential energy based on the SoH, the SoC, and a nameplate capacity N_{c} of the primary battery 212 (e.g., as a function of the SoH, the SoC, and the nameplate capacity N_{c}).

The vertical distance estimator 218 may scale the existing potential energy by the weighted upward efficiency value W_{effu} for estimating the remaining upward vertical distance hᵤₚ according to the first vertical estimation algorithm provided by Equation 1. For example, the vertical distance estimator 218 may scale the first potential energy value by the weighted upward efficiency value W_{effu} for estimating the remaining upward vertical distance hᵤₚ. The vertical distance estimator 218 may scale the existing potential energy by the weighted downward efficiency value W_{effd} for estimating the remaining downward vertical distance h_{down} according to the second vertical estimation algorithm provided by Equation 2. For example, the vertical distance estimator 218 may scale the second potential energy value by the weighted downward efficiency value W_{effd} for estimating the remaining downward vertical distance h_{down}.

The memory device 220 may store an upward efficiency table and a downward efficiency table that are used by the vertical distance estimator 218 to calculate the weighted upward efficiency value W_{effu} and the weighted downward efficiency value W_{effd}, respectively. The upward efficiency table may correspond to the battery electric machine using the primary battery 212. The downward efficiency table may correspond to the battery electric machine using the primary battery 212. The memory device 220 may also store a respective upward efficiency table and a respective downward efficiency table for each battery that may be used to supply power to the battery electric machine. For example, the memory device 220 may store a secondary upward efficiency table and a secondary downward efficiency table that are used by the vertical distance estimator 218 to calculate the weighted upward efficiency value W_{effu} and the weighted downward efficiency value W_{effd}, respectively, when using the secondary battery 216. In addition, the memory device 220 may also store a respective upward efficiency table and a respective downward efficiency table for a replacement primary battery that may be used by the vertical distance estimator 218 to calculate the weighted upward efficiency value W_{effu} and the weighted downward efficiency value W_{effd}, respectively, when using the replacement primary battery.

Each upward efficiency table may be configured to store uphill trip data relevant to the battery electric machine and a corresponding battery. Each downward efficiency table may be configured to store downhill trip data relevant to the battery electric machine and a corresponding battery. The vertical distance estimator 218 may calculate the weighted upward efficiency value W_{effu} based on the uphill trip data and scale the existing potential energy (e.g., the first potential energy value) by the weighted upward efficiency value W_{effu} to estimate the remaining upward vertical distance hᵤₚ. The vertical distance estimator 218 may calculate the weighted downward efficiency value W_{effd} based on the downhill trip data and scale the existing potential energy (e.g., the second potential energy value) by the weighted downward efficiency value W_{effd} to estimate the remaining downward vertical distance h_{down}.

The uphill trip data may include at least one of a total uphill rolling distance, an average uphill grade, an uphill vertical distance, an uphill total mass, an uphill ideal battery energy, an uphill used battery energy, or an uphill trip efficiency value. The downhill trip data may include at least one of a total downhill rolling distance, an average downhill grade, a downhill vertical distance, a downhill total mass, a downhill ideal battery energy, a downhill used battery energy, or a downhill trip efficiency value.

The upward efficiency table may include initial uphill trip data including an initial uphill trip efficiency value. Additionally, the vertical distance estimator 218 may collect or otherwise record the uphill trip data for one or more uphill trips, update the upward efficiency table with the uphill trip data for the one or more uphill trips, and, after each uphill trip of the one or more uphill trips, recalculate the weighted upward efficiency value W_{effu} based on the initial uphill trip efficiency value and the uphill trip data for the one or more uphill trips, and calculate the remaining upward vertical distance hᵤₚ based on the updated weighted upward efficiency value W_{effu}. The vertical distance estimator 218 may calculate an uphill trip efficiency value for each uphill trip of the one or more uphill trips based on respective uphill trip data, and calculate the weighted upward efficiency value W_{effu} as an average of the initial uphill trip efficiency value and one or more uphill trip efficiency values calculated for the one or more uphill trips. An uphill trip may be required to satisfy predetermined trip operational criteria before uphill trip data and an uphill trip efficiency value are recorded in the upward efficiency table. The predetermined trip operational criteria may include: travel a minimum distance of 200 meters, exceed a speed of 5 kph, not be interrupted by a hoist event, and/or the payload mass stays within 5% during the trip. An upward efficiency table may be updated with uphill trip data while a corresponding battery is providing power to the battery electric machine. Thus, an upward efficiency table corresponding to the secondary battery 216 may be used in a similar manner described above.

The downward efficiency table may include initial downhill trip data including an initial downhill trip efficiency value. Additionally, the vertical distance estimator 218 may collect or otherwise record the downhill trip data for one or more downhill trips, update the downward efficiency table with the downhill trip data for the one or more downhill trips, and, after each downhill trip of the one or more downhill trips, recalculate the weighted downward efficiency value W_{effd} based on the initial downhill trip efficiency value and the downhill trip data for the one or more downhill trips, and calculate the remaining downward vertical distance h_{down} based on the weighted downward efficiency value W_{effd}. The vertical distance estimator 218 may calculate a downhill trip efficiency value for each downhill trip of the one or more downhill trips based on respective downhill trip data, and calculate the downward efficiency value as an average of the initial downhill trip efficiency value and one or more downhill trip efficiency values calculated for the one or more downhill trips. A downhill trip may be required to satisfy the predetermined trip operational criteria before downhill trip data and a downhill trip efficiency value are recorded in the downward efficiency table. A downward efficiency table may be updated with downhill trip data while a corresponding battery is providing power to the battery electric machine. Thus, a downward efficiency table corresponding to the secondary battery 216 may be used in a similar manner described above.

As previously described, the battery terminals 214 are configured to connect to the secondary battery 216 for providing auxiliary power. The vertical distance estimator 218 may be configured to, while the secondary battery 216 is connected to the power routing network, monitor a secondary existing potential energy of the secondary battery 216, estimate the remaining upward vertical distance hᵤₚ that the battery electric machine can travel based on the first vertical estimation algorithm, the total mass, and the secondary existing potential energy, and estimate the remaining downward vertical distance h_{down} that the battery electric machine can travel based on the second vertical estimation algorithm, the total mass, and the secondary existing potential energy. For example, the vertical distance estimator 218 may calculate the remaining upward vertical distance hᵤₚ and the remaining downward vertical distance h_{down} in a similar manner described above in connection to the primary battery 212.

Moreover, the battery module 104 may, while using the primary battery 212 as a power source, recharge the secondary battery 216 with recharge energy routed from the primary battery 212. The primary battery 212 may be a replacement primary battery that has been inserted into the battery module 104 during a battery swap. The vertical distance estimator 218 may decrease the remaining upward vertical distance hᵤₚ based on the recharge energy, and may increase the remaining downward vertical distance h_{down} based on the recharge energy. The remaining upward vertical distance hᵤₚ may be decreased based on the recharge energy since the depletion of the primary battery 212 by the recharge energy decreases an amount of charge available to propel the battery electric machine uphill. The remaining downward vertical distance h_{down} may be increased based on the recharge energy since the depletion of the primary battery 212 by the recharge energy increases an amount of charge required to reach the saturation limit of the primary battery.

The first vertical estimation algorithm may be revised according to Equation 3 to account for the recharge energy provided from the primary battery 212 to the secondary battery 216. The second vertical estimation algorithm may be revised according to Equation 4 to account for the recharge energy provided from the primary battery 212 to the secondary battery 216.

$${h}_{u p} = \frac{( {N}_{c} \cdot SoC \cdot SoH - Esec ) \cdot Cjoules}{{M}_{total} \cdot g} {W}_{effu} \qquad Eq . 3$$

$${h}_{down} = \frac{( ( {N}_{c} ( 1 - S o C ) S o H ) + Esec ) \cdot Cjoules}{{M}_{total} \cdot g} {W}_{effd} \qquad Eq . 4$$

The recharge energy used to charge the secondary battery 216 is denoted by Esec. The recharge energy Esec is either subtracted from or added to a battery's base energy, and the weighted efficiency is applied to the recharge energy Esec.

In some implementations, the vertical distance estimator 218 may, based on the first vertical estimation algorithm, decrease the remaining upward vertical distance hᵤₚ based on a first vertical distance value associated with the recharge energy Esec, and may, based on the second vertical estimation algorithm, increase the remaining downward vertical distance h_{down} based on a second vertical distance value associated with the recharge energy Esec. For example, the first vertical distance value may be added to Equation 1, and the second vertical distance value may be added to Equation 2.

As described above, the first potential energy value may be limited or scaled down by a limit value Rlim to account for a depletion limit of the primary battery 212. Similarly, the second potential energy value may be limited or scaled down by the limit value Rlim to account for a saturation limit of the primary battery 212. Thus, the limit value Rlim may be a scaler representing a charge and discharge limit. For example, the limit value Rlim may represent 90% of a full charge for charging (saturation) or 10% of the full charge for discharging (depletion).

As a result, the first vertical estimation algorithm may be revised according to Equation 5 to account for the limit value Rlim. The second vertical estimation algorithm may be revised according to Equation 6 to account for the limit value Rlim. In some cases, different limit values may be used for the first vertical estimation algorithm and the second vertical estimation algorithm.

$${h}_{u p} = \frac{( {N}_{c} \cdot Rlim \cdot SoC \cdot SoH - Esec ) \cdot Cjoules}{{M}_{total} \cdot g} {W}_{effu} \qquad Eq . 5$$

$${h}_{down} = \frac{( ( {N}_{c} ( 1 - S o C ) S oH ) \cdot Rlim + Esec ) \cdot Cjoules}{{M}_{total} \cdot g} {W}_{effd} \qquad Eq . 6$$

In some implementations, the vertical distance estimator 218 may be implemented in a gas-powered machine that includes a combustion engine. For example, the vertical distance estimator 218 may use one or more vertical estimation algorithms, as similarly described herein, for calculating the remaining upward vertical distance and the remaining downward vertical distance based on a remaining fuel level. For a gas-powered machine, the remaining downward vertical distance may correspond to a number of vertical levels a gas-powered machine can travel downhill based on the remaining fuel level before the fuel source is depleted, and the remaining upward vertical distance correspond to a number of vertical levels the gas-powered machine can travel uphill based on the remaining fuel level before the fuel source is depleted. In some implementations, the vertical distance estimator 218 may be implemented in a hybrid-powered vehicle that uses both a gas fuel source and a battery power source. Thus, the vertical distance estimator 218 may be configured for any type of power source.

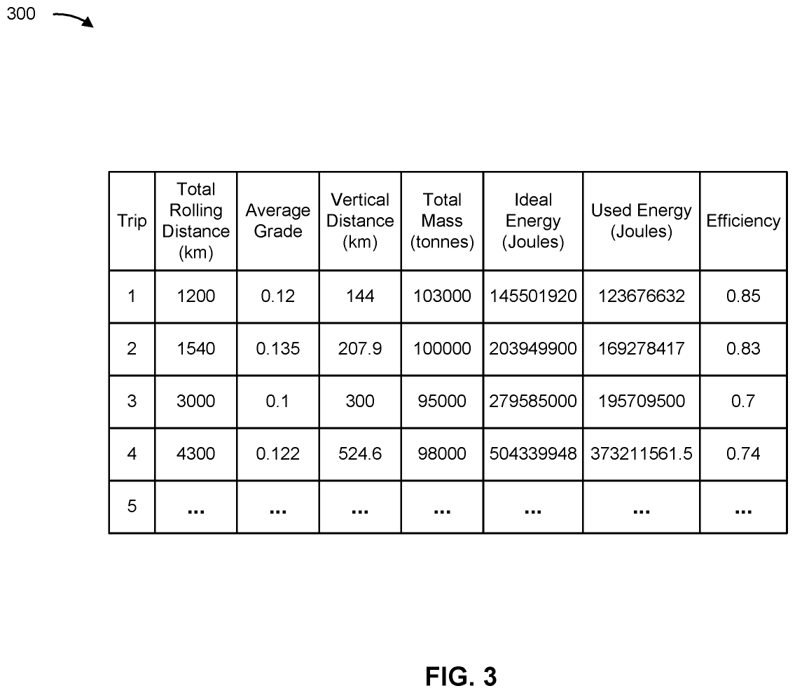

FIG. 3 shows an example of an efficiency table 300 according to one or more implementations. The efficiency table 300 may be an upward efficiency table or a downward efficiency table. Thus, the efficiency table 300 may include initial uphill trip data including an initial uphill trip efficiency value, or may include initial downhill trip data including an initial downhill trip efficiency value. For example, trip 1 may correspond to initial trip data with a trip efficiency value of 0.85. The initial uphill trip data or the initial downhill trip data may be prefabricated (e.g., generated) by the site control system based on historical data and transmitted to the transceiver 206 by the site control system for entry into a corresponding efficiency table. Additionally, the efficiency table 300 may be associated with a primary battery, a secondary battery, or a replacement primary battery.

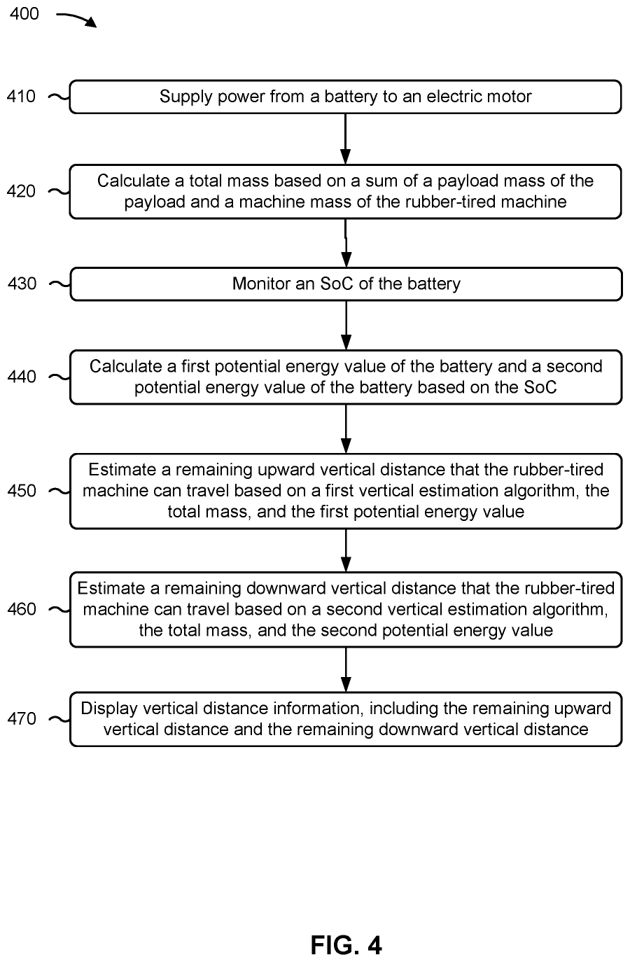

The trip data may include at least one of a total rolling distance, an average grade, a vertical distance, a total mass, an ideal battery energy, a used battery energy, and/or a trip efficiency value. The total rolling distance, the average grade, the vertical distance, the total mass, the ideal battery energy, and/or the used battery energy may be recorded during an approved trip segment, and may be used by the vertical distance estimator 218 to calculate the trip efficiency value for the approved trip segment. The vertical distance estimator 218 may calculate the weighted upward efficiency value W_{effu} as an average of the trip efficiency values of all approved uphill trip segments recorded in the efficiency table 300 and may calculate the weighted downward efficiency value W_{effd} as an average of the trip efficiency values of all approved downhill trip segments recorded in the efficiency table 300. FIG. 4 is a flowchart of an example process 400 associated with vertical range

estimation for a battery electric machine. For example, process 400 may be used to calculate and provide vertical distance information for a rubber-tired machine configured to carry a payload. In some implementations, one or more process blocks of FIG. 4 are performed by a battery electric machine (e.g., battery electric machine 100). In some implementations, one or more process blocks of FIG. 4 are performed by another device or a group of devices separate from or including the battery electric machine, such as another battery electric machine or a site control system. Additionally, or alternatively, one or more process blocks of FIG. 4 may be performed by one or more components of system 200, such as the battery module 104, the BMS 204, and/or the display 110.

As shown in FIG. 4, process 400 may include supplying power from a battery to an electric motor (block 410). For example, the battery module 104 may supply power from a battery to an electric motor, as described above.

As further shown in FIG. 4, process 400 may include calculating a total mass based on a sum of a payload mass of the payload and a machine mass of the rubber-tired machine (block 420). For example, the vertical distance estimator 218 may calculate the total mass based on the sum of the payload mass of the payload and the machine mass of the rubber-tired machine, as described above.

As further shown in FIG. 4, process 400 may include monitoring an SoC of the battery (block 430). For example, the vertical distance estimator 218 may monitor the SoC of the battery, as described above.

As further shown in FIG. 4, process 400 may include calculating a first potential energy value of the battery and a second potential energy value of the battery based on the SoC (block 440). For example, the vertical distance estimator 218 may calculate the first potential energy value of the battery and the second potential energy value of the battery based on the SoC, as described above.

As further shown in FIG. 4, process 400 may include estimating a remaining upward vertical distance that the rubber-tired machine can travel based on a first vertical estimation algorithm, the total mass, and the first potential energy value (block 450). For example, the vertical distance estimator 218 may estimate the remaining upward vertical distance that the rubber-tired machine can travel based on the first vertical estimation algorithm, the total mass, and the first potential energy value, as described above.

As further shown in FIG. 4, process 400 may include estimating a remaining downward vertical distance that the rubber-tired machine can travel based on a second vertical estimation algorithm, the total mass, and the second potential energy value (block 460). For example, the vertical distance estimator 218 may estimate the remaining downward vertical distance that the rubber-tired machine can travel based on the second vertical estimation algorithm, the total mass, and the second potential energy value, as described above.

As further shown in FIG. 4, process 400 may include displaying the vertical distance information, including the remaining upward vertical distance and the remaining downward vertical distance (block 470). For example, the display 110 may display the vertical distance information, including the remaining upward vertical distance and the remaining downward vertical distance, as described above.

Process 400 may include additional implementations, such as any single implementation or any combination of implementations described below and/or in connection with one or more other processes described elsewhere herein. In some implementations, process 400 may be used in gas-powered machines, and the remaining downward vertical distance and the remaining upward vertical distance may be calculated based on a remaining fuel level. For example, the remaining downward vertical distance may correspond to a number of vertical levels a gas-powered machine can travel downhill based on the remaining fuel level, and the remaining upward vertical distance correspond to a number of vertical levels the gas-powered machine can travel uphill based on the remaining fuel level.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The vertical distance estimator 218 may provide two directional estimations for remaining vertical distance, including one remaining vertical distance (e.g., a remaining upward vertical distance or a remaining uphill vertical distance) that the battery electric machine 100 can travel before battery depletion, and another remaining vertical distance (e.g., a remaining downward vertical distance or a remaining downhill vertical distance) that the battery electric machine 100 can travel before battery saturation.

Since an operator of the battery electric machine 100 may have a better sense of how much vertical distance needs to be covered for performing a desired task, rather than how much horizontal distance needs to be covered for performing the desired task, the vertical distance estimator 218 may provide vertical distance information that may be more meaningful to the operator than remaining rolling distance. Moreover, displaying the vertical distance information may help to prevent the operator from developing range anxiety, and may enable the operator to operate the battery electric machine 100 more efficiently within an underground mine.

In addition, the vertical distance information enables the operator to more efficiently navigate the underground mine before reaching a depletion limit or a saturation limit, and may enable the operator to better coordinate with other vehicles within the underground mine. For example, in the upward case, the vertical distance information may assist the operator in determining how many upward levels the battery electric machine 100 can travel (e.g., before the battery reaches a depletion limit) and may be used by the operator to prevent the battery electric machine from becoming stranded within the underground mine, thereby disrupting operations. In the downward case, the vertical distance information may assist the operator in determining how many downward levels the battery electric machine 100 can travel (e.g., before the battery reaches a saturation limit) and may be used by the operator to prevent the battery electric machine from causing congestion within the underground mine, thereby disrupting operations.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A battery electric machine configured to carry a payload, comprising:
a propulsion system, including an electric motor, configured to propel the battery electric machine;
a battery module comprising battery terminals configured to connect to a primary battery and provide power to the propulsion system;
a processing circuit configured to:
monitor an existing potential energy of the primary battery,
estimate a remaining upward vertical distance that the battery electric machine can travel based on a first vertical estimation algorithm and the existing potential energy, and
estimate a remaining downward vertical distance that the battery electric machine can travel based on a second vertical estimation algorithm and the existing potential energy; and
a display configured to indicate the remaining upward vertical distance and the remaining downward vertical distance.

2. The battery electric machine of claim 1, wherein the remaining upward vertical distance is a first vertical range that the battery electric machine can travel in an upward vertical direction before reaching a depletion limit of the primary battery, and
the remaining downward vertical distance is a second vertical range that the battery electric machine can travel in a downward vertical direction before reaching a saturation limit of the primary battery.

3. The battery electric machine of claim 1, wherein the remaining upward vertical distance corresponds to an increase in elevation relative to the battery electric machine, and
wherein the remaining downward vertical distance corresponds to a decrease in elevation relative to the battery electric machine.

4. The battery electric machine of claim 1, wherein the remaining upward vertical distance and the remaining downward vertical distance correspond to vertical distances along a vertical plane, and the battery electric machine is a tired machine configured to travel along a driving plane that intersects the vertical plane.

5. The battery electric machine of claim 1, wherein the processing circuit is configured to:
calculate a total mass based on a sum of a payload mass of the payload and a machine mass of the battery electric machine,
estimate the remaining upward vertical distance that the battery electric machine can travel based on the first vertical estimation algorithm, the total mass, and the existing potential energy, and
estimate the remaining downward vertical distance that the battery electric machine can travel based on the second vertical estimation algorithm, the total mass, and the existing potential energy.

6. The battery electric machine of claim 5, further comprising:
at least one sensor configured to sense the payload mass of the payload and generate at least one sensor signal representative of the payload mass,
wherein the processing circuit is configured to receive the at least one sensor signal and calculate the total mass based on a sum of the payload mass, indicated by the at least one sensor signal, and the machine mass of the battery electric machine, and
wherein the at least one sensor includes a torque sensor or a pressure sensor.

7. The battery electric machine of claim 1, wherein processing circuit is configured to calculate a state of health (SoH) of the primary battery, calculate a state of charge (SoC) of the primary battery, and calculate the existing potential energy based on the SoH and the SoC.

8. The battery electric machine of claim 7, wherein processing circuit is configured to calculate the existing potential energy based on the SoH, the SoC, and a nameplate capacity of the primary battery.

9. The battery electric machine of claim 1, wherein processing circuit is configured to scale the existing potential energy by a weighted upward efficiency value for estimating the remaining upward vertical distance according to the first vertical estimation algorithm, wherein the weighted upward efficiency value corresponds to an uphill operational efficiency of the battery electric machine, and
wherein processing circuit is configured to scale the existing potential energy by a weighted downward efficiency value for estimating the remaining downward vertical distance according to the second vertical estimation algorithm, wherein the weighted downward efficiency value corresponds to a downhill operational efficiency of the battery electric machine.

10. The battery electric machine of claim 9, wherein the uphill operational efficiency is an operational efficiency of the battery electric machine while using the primary battery for uphill movement, and
wherein the downhill operational efficiency is an operational efficiency of the battery electric machine while using the primary battery for downhill movement.

11. The battery electric machine of claim 1, wherein the processing circuit includes at least one memory configured to store an upward efficiency table and downward efficiency table,
wherein the upward efficiency table corresponds to the battery electric machine while using the primary battery,
wherein the downward efficiency table corresponds to the battery electric machine while using the primary battery,
wherein the upward efficiency table is configured to store uphill trip data,
wherein the downward efficiency table is configured to store downhill trip data,
wherein the processing circuit is configured to calculate an upward efficiency value based on the uphill trip data and scale the existing potential energy by the upward efficiency value to estimate the remaining upward vertical distance, and
wherein the processing circuit is configured to calculate a downward efficiency value based on the downhill trip data and scale the existing potential energy by the downward efficiency value to estimate the remaining downward vertical distance.

12. The battery electric machine of claim 11, wherein the uphill trip data includes at least one of a total uphill rolling distance, an average uphill grade, an uphill vertical distance, an uphill total mass, an uphill ideal battery energy, an uphill used battery energy, or an uphill trip efficiency value, and
wherein the downhill trip data includes at least one of a total downhill rolling distance, an average downhill grade, a downhill vertical distance, a downhill total mass, a downhill ideal battery energy, a downhill used battery energy, or a downhill trip efficiency value.

13. The battery electric machine of claim 11, wherein the upward efficiency table includes initial uphill trip data including an initial uphill trip efficiency value,
wherein the processing circuit is configured to collect the uphill trip data for one or more uphill trips, update the upward efficiency table with the uphill trip data for the one or more uphill trips, and, after each uphill trip of the one or more uphill trips, recalculate the upward efficiency value based on the initial uphill trip efficiency value and the uphill trip data for the one or more uphill trips, and calculate the remaining upward vertical distance based on the upward efficiency value,
wherein the downward efficiency table includes initial downhill trip data including an initial downhill trip efficiency value, and
wherein the processing circuit is configured to collect the downhill trip data for one or more downhill trips, update the downward efficiency table with the downhill trip data for the one or more downhill trips, and, after each downhill trip of the one or more downhill trips, recalculate the downward efficiency value based on the initial downhill trip efficiency value and the downhill trip data for the one or more downhill trips, and calculate the remaining downward vertical distance based on the downward efficiency value.

14. The battery electric machine of claim 13, wherein the processing circuit is configured to calculate an uphill trip efficiency value for each uphill trip of the one or more uphill trips based on respective uphill trip data, and calculate the upward efficiency value as an average of the initial uphill trip efficiency value and one or more uphill trip efficiency values calculated for the one or more uphill trips, and
wherein the processing circuit is configured to calculate a downhill trip efficiency value for each downhill trip of the one or more downhill trips based on respective downhill trip data, and calculate the downward efficiency value as an average of the initial downhill trip efficiency value and one or more downhill trip efficiency values calculated for the one or more downhill trips.

15. The battery electric machine of claim 1, wherein the battery terminals are configured to connect to a secondary battery for providing auxiliary power,
wherein the processing circuit is further configured to monitor a secondary existing potential energy of the secondary battery,
wherein the processing circuit is further configured to estimate the remaining upward vertical distance that the battery electric machine can travel based on the first vertical estimation algorithm, a total mass of the battery electric machine and the payload, and the secondary existing potential energy, and
wherein the processing circuit is further configured to estimate the remaining downward vertical distance that the battery electric machine can travel based on the second vertical estimation algorithm, the total mass, and the secondary existing potential energy.

16. The battery electric machine of claim 1, wherein the battery terminals are configured to connect to a secondary battery and provide a power swap with the primary battery,
wherein the battery module is configured to, while using the primary battery as a power source, recharge the secondary battery with recharge energy routed from the primary battery,
wherein the processing circuit is configured to decrease the remaining upward vertical distance based on the recharge energy, and
wherein the processing circuit is configured to increase the remaining downward vertical distance based on the recharge energy.

17. A tired machine configured to carry a payload, comprising:
a propulsion system, including an electric motor, configured to propel the tired machine;
a battery module comprising battery terminals configured to connect to a battery and provide power to the propulsion system;
a vertical distance estimator comprising at least one processor, where the vertical distance estimator is configured to determine a payload mass of the payload,
wherein the vertical distance estimator is further configured to monitor a state of charge (SoC) of the battery and calculate a first potential energy value of the battery and a second potential energy value of the battery based on the SoC,
wherein the vertical distance estimator is further configured to estimate a remaining upward vertical distance that the tired machine can travel based on a first vertical estimation algorithm, the payload mass, and the first potential energy value, and
wherein the vertical distance estimator is further configured to estimate a remaining downward vertical distance that the tired machine can travel based on a second vertical estimation algorithm, the payload mass, and the second potential energy value; and
a display configured to indicate the remaining upward vertical distance and the remaining downward vertical distance.

18. The tired machine of claim 17, wherein the remaining upward vertical distance is a first vertical range that the tired machine can travel in an upward vertical direction before the battery reaches a depletion limit, and
the remaining downward vertical distance is a second vertical range that the tired machine can travel in a downward vertical direction before the battery reaches a saturation limit.

19. The tired machine of claim 17, wherein the vertical distance estimator includes at least one memory configured to store an upward efficiency table and downward efficiency table,
wherein the upward efficiency table corresponds to the tired machine while using the battery,
wherein the downward efficiency table corresponds to the tired machine while using the battery,
wherein the upward efficiency table is configured to store uphill trip data,
wherein the downward efficiency table is configured to store downhill trip data,
wherein the vertical distance estimator is configured to calculate an upward efficiency value based on the uphill trip data and calculate the first potential energy value based on the upward efficiency value, and
wherein the vertical distance estimator is configured to calculate a downward efficiency value based on the downhill trip data and calculate the second potential energy value based on the downward efficiency value.

20. A method of providing vertical distance information for a tired machine configured to carry a payload, the method comprising:
supplying, by a battery module, power from a battery to an electric motor;
calculating, by a processing circuit, a total mass based on a sum of a payload mass of the payload and a machine mass of the tired machine;
monitoring, by the processing circuit, a state of charge (SoC) of the battery;
calculating, by the processing circuit, a first potential energy value of the battery and a second potential energy value of the battery based on the SoC;
estimating, by the processing circuit, a remaining upward vertical distance that the tired machine can travel based on a first vertical estimation algorithm, the total mass, and the first potential energy value;
estimating, by the processing circuit, a remaining downward vertical distance that the tired machine can travel based on a second vertical estimation algorithm, the total mass, and the second potential energy value; and
displaying, by a display, the vertical distance information, including the remaining upward vertical distance and the remaining downward vertical distance.
